(19) United States
(12) Patent Application Publication
(10) Pub. No.: US 2016/0359161 A1
(43) Pub. Date: Dec. 8, 2016

(54) Positive Electrode for Lithium-Sulfur Secondary Battery and Method of Forming the Same

(71) Applicant: ULVAC, INC., Kanagawa (JP)

(72) Inventors: Tatsuhiro Nozue, Kanagawa (JP); Yoshiaki Fukuda, Kanagawa (JP); Naoki Tsukahara, Kanagawa (JP); Hirohiko Murakami, Kanagawa (JP)

(73) Assignee: ULVAC, INC., Kanagawa (JP)

(21) Appl. No.: 15/101,072

(22) PCT Filed: Oct. 15, 2014
(86) PCT No.: PCT/JP2014/005230

§ 371 Date: Jun. 2, 2016

(30) Foreign Application Priority Data
Dec. 16, 2013 (JP) 2013-259254

(51) Int. Cl. H01M 4/04; H01M 4/62; H01M 4/133; H01M 4/583; H01M 4/36; H01M 4/38; H01M 4/66; H01M 10/0525; H01M 4/134

(52) U.S. Cl. CPC H01M 4/0428; H01M 10/0525; H01M 4/625; H01M 4/0404; H01M 4/133; H01M 4/134; H01M 4/366; H01M 4/38; H01M 4/661; H01M 4/583; H01M 4/667; H01M 2004/028

(57) ABSTRACT

Provided is a positive electrode for a lithium-sulfur secondary battery capable of surely covering a portion of carbon nanotubes near a collector with sulfur and having an excellent strength. In a positive electrode for a lithium-sulfur secondary battery including a collector, a plurality of carbon nanotubes grown on a surface of the collector so as to be oriented in a direction perpendicular to the surface of the collector with a base end thereof on a side of the surface of the collector, and sulfur covering a surface of each of the carbon nanotubes, a surface of each of the carbon nanotube is covered with sulfur by melting and diffusing sulfur from a growing end side of the carbon nanotubes, and the density per unit volume of the carbon nanotubes is set such that sulfur is present up to an interface between the collector and the base end.

### TECHNICAL FIELD

The present invention relates to a positive electrode for a lithium-sulfur secondary battery and a method of forming the same.

### BACKGROUND ART

Since a lithium secondary battery has a high energy density, an application range thereof is not limited to a handheld equipment such as a mobile phone or a personal computer, but is expanded to a hybrid automobile, an electric automobile, an electric power storage system, and the like. Among these secondary batteries, attention has been recently paid to a lithium-sulfur secondary battery for charging and discharging through a reaction between lithium and sulfur by using sulfur as a positive electrode active material and lithium as a negative electrode active material.

As a positive electrode for such a lithium-sulfur secondary battery, for example, Patent Document 1 discloses a positive electrode including a collector, a plurality of carbon nanotubes grown on a surface of the collector so as to be oriented in a direction perpendicular to the surface of the collector with a base end thereof on a side of the surface of the collector, and sulfur covering a surface of each of of the carbon nanotubes (in general, the density per unit volume of a carbon nanotube is 0.06 g/cm³, and the weight of sulfur is 0.7 to 3 times the weight of a carbon nanotube). By application of this positive electrode to a lithium-sulfur secondary battery, an electrolyte comes into contact with sulfur in a wide area, and a utilization efficiency of sulfur is thereby improved.

Therefore, a lithium-sulfur secondary battery having an excellent charge-discharge rate characteristic and a large specific capacity (discharge capacity per unit weight of sulfur) is obtained.

Here, as a method of covering a surface of each of the carbon nanotubes with sulfur, a method of placing sulfur at a growing end of the carbon nanotubes to be melted and diffusing the melted sulfur to a base-end side through a gap between the respectively adjacent carbon nanotubes is generally known. However, by such a method, sulfur is present unevenly only near the growing end of the carbon nanotubes, and is not diffused to the vicinity of the base end of the carbon nanotubes. The vicinity of the base end is not covered with sulfur or may be covered with sulfur having an extremely thin film thickness even when being covered. This does not bring about a lithium-sulfur secondary battery having an excellent charge-discharge rate characteristic and a large specific capacity. This is caused by the following fact. That is, the melted sulfur has a high viscosity, and the width of the gap becomes smaller due to an intermolecular force between the carbon nanotubes. Therefore, the melted sulfur is hardly diffused downward in the gap, and sulfur cannot be supplied up to the vicinity of a lower end of the carbon nanotubes efficiently.

Therefore, the inventors of this invention made intensive studies and have found the following. That is, by setting the density of the carbon nanotubes per unit volume to a value half the density in related art or lower, even by a similar method to above, sulfur can be efficiently supplied up to an interface between a collector and a base end of the carbon nanotubes when sulfur is melted and diffused.

However, it has been found that sulfur adhering to the surface of the carbon nanotubes between the base end of the carbon tubes and the growing end thereof is partially exfoliated or adhesion of sulfur is significantly deteriorated by reduction in the density of the carbon nanotubes per unit volume. It is considered that this is caused by the following fact. That is, reduction in the density of the carbon nanotubes reduces the strength of the entire carbon nanotubes grown on the surface of the collector, and each of the carbon nanotubes is thermally shrunk (deformed) when sulfur is melted and diffused. In this case, when sulfur is partially exfoliated, the exfoliated portion does not act as a lithium-sulfur secondary battery. When charge-discharge is performed by housing the carbon nanotubes in a battery can while the adhesion of sulfur is deteriorated and assembling a lithium-sulfur secondary battery using the battery can, a sulfur active material of a positive electrode is lost, and finally the specific capacity is largely deteriorated by repeated charge-discharge.

### PRIOR ART DOCUMENT

### Patent Document

Patent Document 1: WO 2012/070184 A

### SUMMARY OF INVENTION

### Problem

In view of the above points, an object of the invention is to provide a positive electrode for a lithium-sulfur secondary battery capable of surely covering a portion of carbon nanotubes near a collector with sulfur and having an excellent strength, and a method of forming the same.

### Means for Solving the Problems

In order to solve the above problems, in a positive electrode for a lithium-sulfur secondary battery comprising: a collector; a plurality of carbon nanotubes which are grown on a surface of the collector such that the collector-surface side serves as a base end and so as to be oriented in a direction perpendicular to the surface of the collector; each of the carbon nanotubes being respectively covered with sulfur on a surface thereof, the surface of each of the carbon nanotubes being covered with sulfur by melting and diffusing sulfur from a growing end side of the carbon nanotubes. The invention is characterized in that the density per unit volume of the carbon nanotubes is set such that: when sulfur is melted and diffused, sulfur is present up to an interface between the collector and the base end of each of the carbon nanotubes; and that the positive electrode further comprises amorphous carbon covering the surface of each of the carbon nanotubes.

According to the above arrangement, the surfaces of the carbon nanotubes are covered with amorphous carbon. Therefore, the strength of the carbon nanotubes as a whole as grown on the surface of the collector can be 10% or less even when the carbon nanotubes are pressed from the growing end side thereof at a pressure of 0.5 MPa per unit area. An excellent strength is obtained. Therefore, a deformation amount of the carbon nanotubes becomes less when sulfur is melted from the growing end of the carbon nanotubes. Sulfur adhering to the surfaces of the carbon nanotubes between the base end of the carbon tubes and the growing end thereof is efficiently prevented from being partially exfoliated, or adhesion of sulfur is efficiently prevented from being significantly deteriorated. In this case, since the density is made low, sulfur is diffused up to the base end side through a gap between the respectively adjacent carbon nanotubes. The surface of the amorphous carbon, consequently, the surfaces of the carbon nanotubes are surely covered with sulfur having a predetermined film thickness from the growing end to the base end.

In the invention, the density is preferably 0.025 g/cm³ or less and within a range capable of obtaining a predetermined specific capacity. The lower limit of the density is preferably 0.010 g/cm³ or more considering practicality or the like.

In order to solve the above problems, a method of forming a positive electrode for a lithium-sulfur secondary battery of the invention comprises: a growth step of forming a catalyst layer on a surface of a substrate, and growing a plurality of carbon nanotubes on a surface side of the catalyst layer such that the catalyst-layer side surface serves as a base end and so as to be oriented in a direction perpendicular to the surface of the catalyst layer; and a coverage step of melting and diffusing sulfur from the growing end side of each of the carbon nanotubes and covering a surface of each of the carbon nanotubes with sulfur. The invention is characterized in that the growth step includes: a first step of growing the carbon nanotubes by setting the concentration of a hydrocarbon gas to a first concentration using a CVD method in which a mixed gas of the hydrocarbon gas and a diluent gas are used as a raw material gas, and a second step of covering the surface of each of the carbon nanotubes with amorphous carbon by setting the concentration of the hydrocarbon gas to a second concentration higher than the first concentration.

According to the above, for example, only by changing the concentration (flow rate) of the raw material gas, growing the carbon nanotubes and covering the surface of each of the carbon nanotubes with amorphous carbon by setting the concentration of the hydrocarbon gas to the second concentration which is higher than the first concentration can be performed continuously in a single film-forming chamber. Productivity for manufacturing a positive electrode can be improved.

In this case, the hydrocarbon gas only needs to be selected from acetylene, ethylene, and methane. The first concentration only needs to be from 0.1% to 1%, and the second concentration only needs to be from 2% to 10%.

### BRIEF DESCRIPTION OF DRAWINGS

FIG. 1 is a cross sectional view schematically illustrating a structure of a lithium-sulfur secondary battery according to an embodiment of this invention.

FIG. 2 is a cross sectional view schematically illustrating a positive electrode for a lithium-sulfur secondary battery according to the embodiment of the invention.

FIGS. 3(a) to 3(c) are cross sectional views schematically illustrating procedures for forming the positive electrode for a lithium-sulfur secondary battery according to the embodiment of the invention.

FIG. 4 is a graph illustrating control of a temperature and a gas concentration when carbon nanotubes are grown by a CVD method and the carbon nanotubes are covered with amorphous carbon.

FIGS. 5(a) and 5(b) are cross-sectional SEM photographs of samples 1 and 2 which are carbon nanotubes manufactured in order to show an effect of the invention.

FIGS. 6(a) and 6(b) are graphs showing charge-discharge characteristics of sample 1 and sample 2 manufactured in order to show the effect of the invention.

### DESCRIPTION OF EMBODIMENT

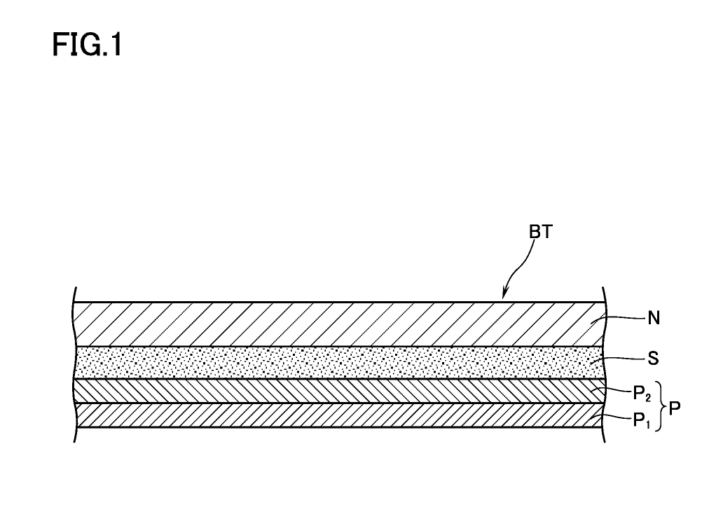

Hereinafter, a positive electrode for a lithium-sulfur secondary battery and a method of forming the same according an embodiment of the invention will be described with reference to the drawings. With reference to FIG. 1, a lithium-sulfur secondary battery BT mainly includes a positive electrode P, a negative electrode N, a separator S disposed between the positive electrode P and the negative electrode N, and an electrolyte (not illustrated) having a conductivity of a lithium ion (Lit) between the positive electrode P and the negative electrode N, and is housed in an electric can (not illustrated). Examples of the negative electrode N include Li, an alloy of Li and Al, In, or the like, and Si, SiO, Sn, SnO₂, and hard carbon doped with lithium ions. Examples of the electrolyte include at least one selected from ether-based electrolytic solutions such as tetrahydrofuran glyme, diglyme, triglyme, and tetraglyme, and a mixture of at least one of these (for example, glyme, diglyme, or tetraglyme) and dioxolane for viscosity adjustment. Since known elements can be used as the other constituent elements other than the positive electrode P, detailed description thereof is omitted herein.

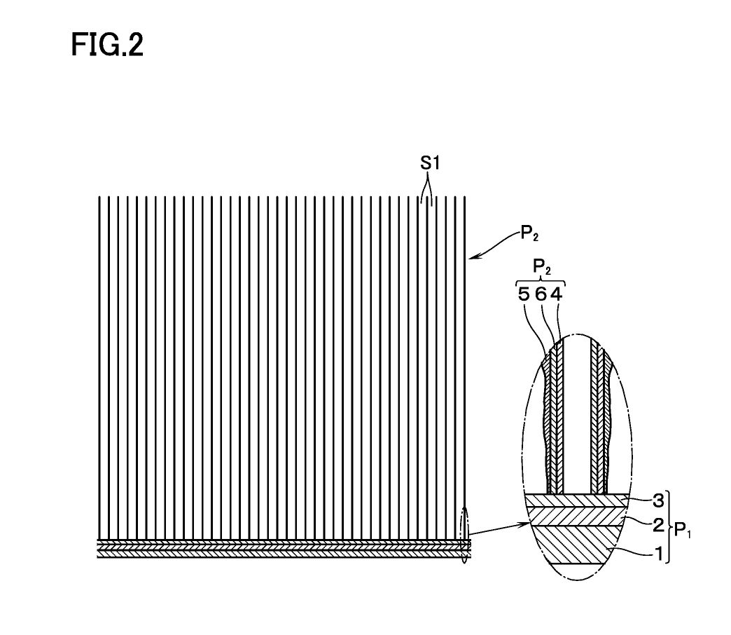

The positive electrode P includes a collector P₁ and a positive electrode active material layer P₂ formed on a surface of the collector P₁. As illustrated in FIG. 2, the collector P₁ includes, for example, a substrate 1, an underlying film (also referred to as “a barrier film”) 2 formed on a surface of the substrate 1 and having a film thickness of 4 to 100 nm, and a catalyst layer 3 formed on a surface of the underlying film 2 and having a film thickness of 0.2 to 5 nm. A metal foil made of Ni, Cu, or Pt, for example, can be used as the substrate 1. The underlying film 2 is used for improving adhesion between the substrate 1 and carbon nanotubes described below. For example, the underlying film 2 is formed of at least one metal selected from Al, Ti, V, Ta, Mo, and W, or a nitride thereof. For example, the catalyst layer 3 is formed of at least one metal selected from Ni, Fe, and Co, or an alloy thereof. For example, the underlying film 2 and the catalyst layer 3 can be formed by using a well-known electron beam vapor deposition method, a sputtering method, or dipping using a solution of a compound containing a catalyst metal. The film thickness of the underlying film 2 is preferably 20 times or more that of the catalyst layer 3. This is for reducing the density of carbon nanotubes 4.

That is, as described below, when the carbon nanotubes 4 are grown by a CVD method, the catalyst layer 3 forms microparticles serving as a nucleus of growth of the carbon nanotubes 4, and is alloyed with the underlying layer 2 simultaneously. In this case, it is known that the density of the carbon nanotubes 4 is improved by formation of an auxiliary catalyst layer having a thickness of ⅕ to ½ of the thickness of the catalyst layer between the catalyst layer 3 and the underlying film 2. On the contrary, the density of the microparticles can be reduced and the carbon nanotubes 4 can be grown at a low density by formation of the underlying layer 2 having a thickness of 20 times the catalyst layer 3 or more.

The positive electrode active material layer P₂ is constituted by a plurality of the carbon nanotubes 4 which are grown on a surface of the collector P₁ such that the surface side of the collector P₁ serves as a base end and so as to be oriented in a direction perpendicular to the surface of the collector P₁, and sulfur 5 covering a surface of each of the carbon nanotubes 4. In this case, there is a predetermined gap S1 between the respectively adjacent carbon nanotubes 4, and an electrolyte (electrolytic solution) flows into this gap S1. As a method of growing the carbon nanotubes 4 (growth step), a CVD method using a mixed gas of a hydrocarbon gas and a diluent gas as a raw material gas, such as a thermal CVD method, a plasma CVD method, or a hot filament CVD method, is used. On the other hand, as a method of covering a surface of each of the carbon nanotubes 4 with the sulfur 5 (coverage step), granular sulfur 51 is sprayed to the growing end of the carbon nanotubes 4, the sulfur 51 is heated to the melting point of the sulfur 51 (113° C.) or higher for melting it, and the melted sulfur 51 is diffused to the base end side through the gap S1 between the respectively adjacent carbon nanotubes 4.

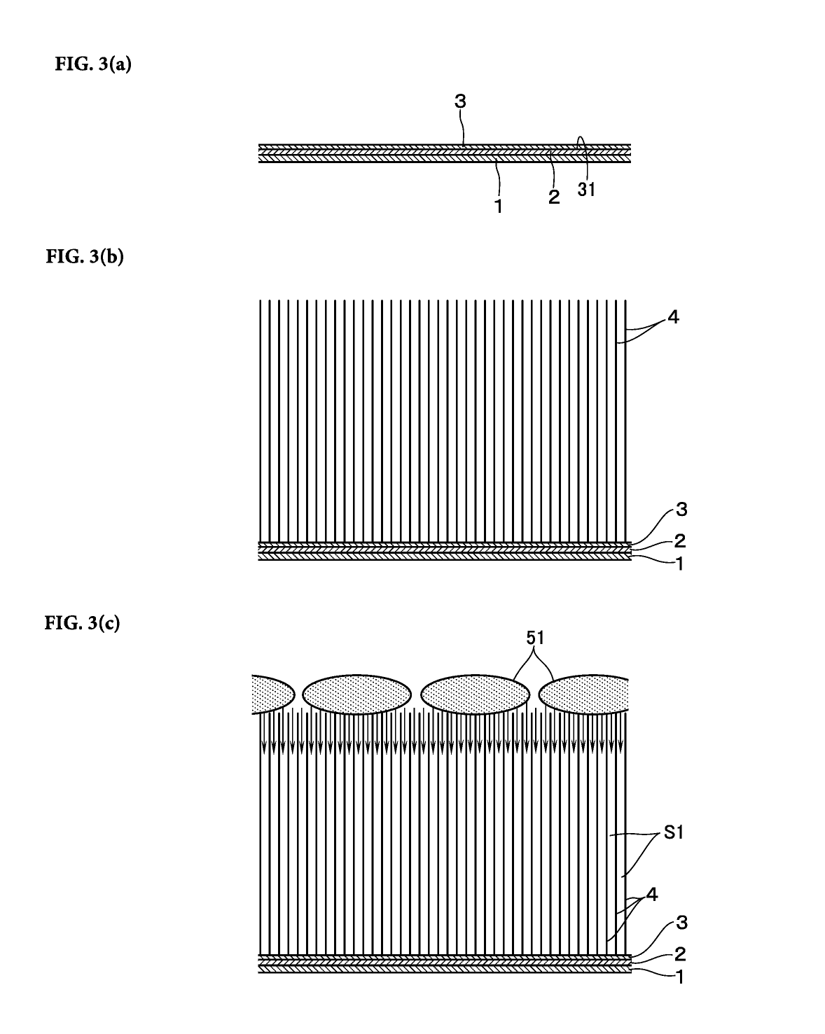

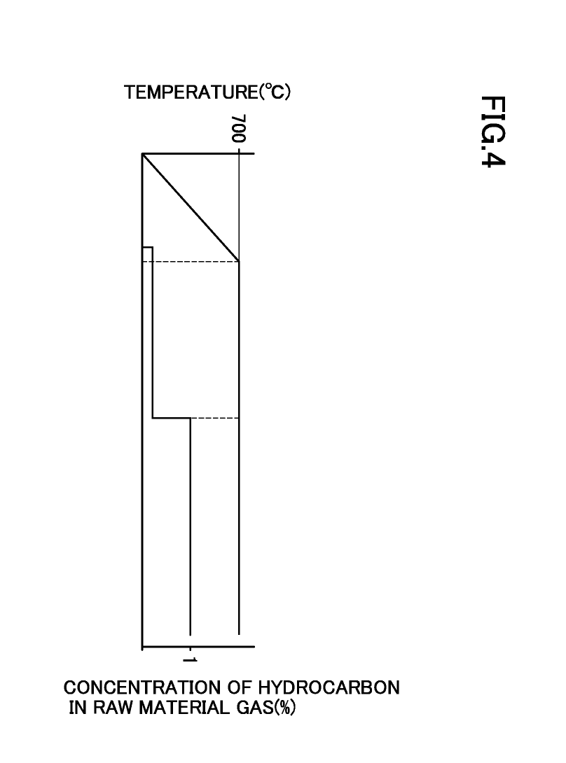

By the way, in order to surely diffuse the melted sulfur 51 down to the base end side through the gap between the respectively adjacent carbon nanotubes 4, it is only necessary to set the density of the carbon nanotubes 4 per unit volume to a low value. However, this reduces the strength of the entire carbon nanotubes 4. Therefore, it is necessary to prevent the sulfur 5 covering of each of the carbon nanotubes 4 from being partially exfoliated, or to prevent the adhesion properties of the sulfur 51 from being deteriorated. Therefore, in the embodiment, before the sulfur 5 is diffused, the surfaces of the carbon nanotubes 4 are covered with amorphous carbon 6. Hereinafter, a method of forming a positive electrode for a lithium-sulfur secondary battery according to the embodiment will described with reference to FIGS. 3 and 4.

According to the above procedures, the underlying film 2 is formed on a surface of the substrate 1, and the catalyst layer 3 is formed on a surface of the underlying film 2 to manufacture the collector P₁ (see FIG. 1(a)). Subsequently, as the growth step, the collector P₁ is disposed in a vacuum chamber which defines a film-forming chamber of a CVD apparatus (not illustrated), and is heated. A raw material gas containing a hydrocarbon gas and a diluent gas is introduced into the film-forming chamber, and the carbon nanotubes 4 are grown by a thermal CVD method (first step). While the collector P₁ is continuously heated so as to be maintained at the same temperature, the concentration of the hydrocarbon gas in the raw material gas is increased, and a surface of each of the carbon nanotubes 4 is covered with the amorphous carbon 6 (second step). In this case, the raw material gas is supplied into the film-forming chamber at an operation pressure of 100 Pa to the atmospheric pressure, and the collector P₁ is heated so as to be heated to a temperature of 600 to 800° C., for example, at 700° C. and is maintained at that temperature.

Examples of the hydrocarbon gas include methane, ethylene, acetylene, and the like. Examples of the diluent gas include nitrogen, argon, hydrogen, and the like. In the first step, the flow rate of the raw material gas is set to 100 to a range of 5000 sccm according to an inner volume of the film-forming chamber, an area of the collector P₁ in which the carbon nanotubes 4 are grown, and the like. At this time, the concentration of the hydrocarbon gas in the raw material gas is set to a range of 0.1% to 1%. When the temperature of the film-forming chamber reaches a predetermined temperature (for example, 500° C.), the raw material gas is introduced thereinto. Then, the carbon nanotubes 4 are grown until having a predetermined length. Thereafter, in the second step, the flow rate of the raw material gas is set to the same flow rate as in the first step, and the concentration of the hydrocarbon gas in the raw material gas at this time is changed to a range of 2% to 10%.

According to this arrangement, in the first step, the plurality of carbon nanotubes 4 are thereby grown on the surface of the collector P₁ so as to be oriented in a direction perpendicular to the surface of the collector P₁ at a density of 0.025 g/cm³ or less (in this case, the length is in the range from 100 to 1000 μm, and the diameter is in the range from 5 to 50 nm). In the second step, the surface of each of the carbon nanotubes 4 is covered with the amorphous carbon 6 over an entire length thereof from the base end up to the growing end (see FIG. 3(b)). In this case, in the first step, when the concentration of the hydrocarbon gas in the raw material gas is outside a range of 0.1% to 1%, the carbon nanotubes 4 cannot be grown at the above density. In the second step, when the concentration of the hydrocarbon gas is less than 2%, the surface of each of the carbon nanotubes 4 cannot be surely covered with the amorphous carbon 6 over an entire length thereof. In the second step, when the concentration of the hydrocarbon gas is more than 10%, the inside of a furnace is contaminated with a tar-like product generated by decomposition of an excessive amount of the hydrocarbon, and continuous manufacturing is difficult.

Subsequently, as the coverage step, the plurality of carbon nanotubes 4 are grown on the collector P₁, and a surface of each of the carbon nanotubes 4 is covered with the amorphous carbon 6. Thereafter, the granular sulfur 51 having a particle diameter of 1 to 100 μm is sprayed from above over the entire area in which the carbon nanotubes 4 have been grown. The weight of the sulfur 51 is only necessary to be set to a value 0.2 to 10 times that of the carbon nanotubes 4. When the weight is less than 0.2 times, the surface of each of the carbon nanotubes 4 fails to be evenly covered with sulfur. When the weight is more than 10 times, even the gap between the respectively adjacent carbon nanotubes 4 is filled with the sulfur 5.

Then, the positive electrode collector P₁ is disposed in a heating furnace (not illustrated) and is heated to a temperature of 120 to 180° C. not less than the melting point of sulfur, and the sulfur 51 is melted. In this case, the density of each of the carbon nanotubes 4 per unit volume is set to 0.025 g/cm³ or less. Therefore, the melted sulfur 51 flows into the gap between the respectively adjacent carbon nanotubes 4, and is surely diffused down to the base end of the carbon nanotubes. The entire surfaces of the carbon nanotubes 4, consequently, the entire surface of the amorphous carbon 6 is covered with the sulfur 5 having a thickness of 1 to 3 nm. The gap Si comes to be present between the respectively adjacent carbon nanotubes 4 (see FIG. 2). When sulfur is heated in the air, the melted sulfur reacts with water in the air to generate sulfur dioxide. Therefore, it is preferable to heat sulfur in an inert gas atmosphere such as N₂, Ar, or He, or in vacuo.

In the positive electrode P according to the above embodiment, the surfaces of the carbon nanotubes 4 are covered with the amorphous carbon 6. Therefore, as for the strength of the entire carbon nanotubes 4 grown on the surface of the collector P₁, for example, a variation of the length of the carbon nanotubes 4 in a growing direction can be 10% or less even when the carbon nanotubes 4 are pressed on the growing end side at a pressure of 0.5 MPa per unit area. An excellent strength is obtained. Therefore, as described above, a shrinkage amount (deformation amount) of each of the carbon nanotubes 4 becomes less when sulfur is melted. Sulfur adhering to the surfaces of the carbon nanotubes 4 between the base end of the carbon nanotubes 4 and the growing end thereof is efficiently prevented from being partially exfoliated, or adhesion of sulfur is efficiently prevented from being significantly deteriorated. Only by changing the concentration (flow rate) of the raw material gas, growing the carbon nanotubes 4 (first step) and covering the surface of each of the carbon nanotubes 4 with the amorphous carbon 6 by setting the concentration of the hydrocarbon gas to the second concentration which is higher than the first concentration (second step) can be performed continuously in a single film-forming chamber. Productivity for manufacturing the positive electrode P can be improved.

When the lithium-sulfur secondary battery BT is assembled using the positive electrode P manufactured as described above, an entire surface of each of the carbon nanotubes 4 is covered with the sulfur 5. Therefore, the sulfur 5 comes into contact with the carbon nanotubes 4 in a wide area, and an electron can be donated to the sulfur 5 sufficiently. At this time, the sulfur 5 comes into contact with the electrolytic solution in a wide area because an electrolytic solution is supplied to the gap S1 between the respectively adjacent carbon nanotubes 4. This further increases the utilization efficiency of the sulfur 5, and leads to achievement of a particularly high rate characteristic and a further increased specific capacity in cooperation with sufficient donation of electrons to the sulfur. In addition, a polysulfide anion generated by the sulfur 5 during discharge is adsorbed by the carbon nanotubes 4. Therefore, diffusion of the polysulfide anion into the electrolytic solution can be suppressed, and a favorable charge-discharge cycling characteristic is obtained.

Next, the following experiment was performed in order to confirm an effect of the invention. In a first experiment, a Ni foil having a thickness of 0.020 mm was used as the substrate 1. An Al film having a thickness of 50 nm as the underlying film 2 was formed on a surface of the Ni foil by an electron beam evaporation method, and an Fe film having a thickness of 1 nm as the catalyst layer 3 was formed on a surface of the underlying film 2 by an electron beam evaporation method to obtain the collector P₁. Subsequently, the collector P₁ was disposed in a processing chamber of a thermal CVD apparatus. While acetylene at 2 sccm and nitrogen at 998 sccm were supplied into the processing chamber (first concentration: 0.2%), the carbon nanotubes 4 were grown on the surface of the collector P₁ at an operation pressure of 1 atmospheric pressure at a heating temperature of 700° C. at a growing time of 30 minutes. At this time, the average length of each of the carbon nanotubes was about 800 μm, and the average density per unit volume thereof was about 0.025 g/cm³. After elapse of 30 minutes as the growing time, while acetylene at 500 sccm and nitrogen at 950 sccm were supplied into the processing chamber (second concentration: 5%), the surfaces of the carbon nanotubes 4 grown on the surface of the collector P₁ for ten minutes were covered with the amorphous carbon 6 to be used as sample 1. As a comparative experiment, the carbon nanotubes 4 were grown under the same conditions as above, and the carbon nanotubes 4 the surfaces of which were not covered with the amorphous carbon 6 were obtained to be used as sample 2.

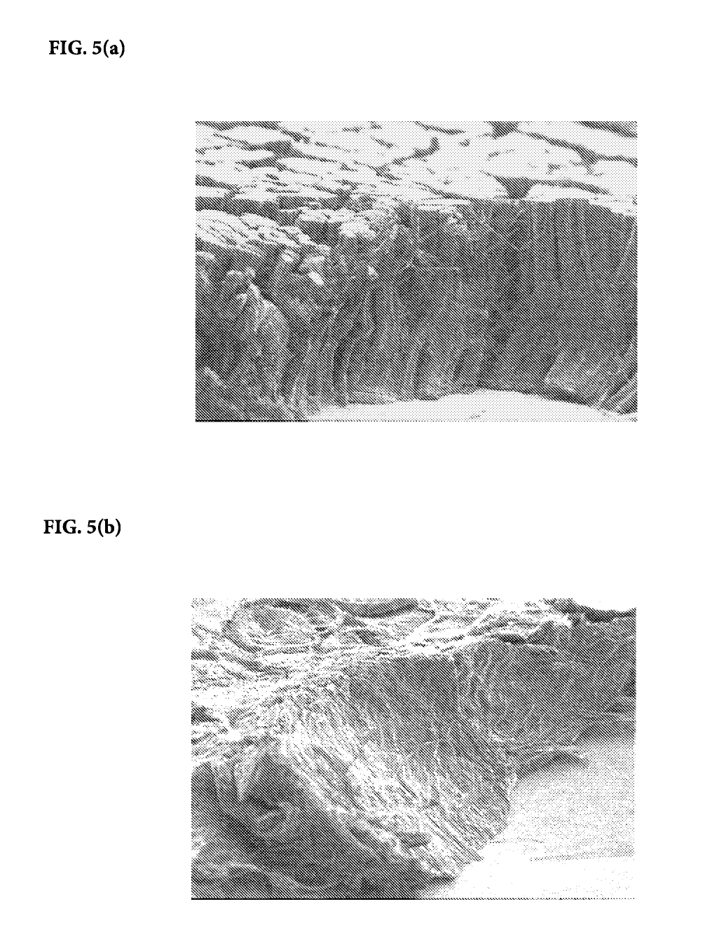

FIGS. 5(a) and 5(b) are SEM images of samples 1 and 2, obtained by pressing the carbon nanotubes 4 on the growing end side at a pressure of 0.5 MPa per unit area. This indicates that, in sample 2, the strength is low due to the low density and each of the carbon nanotubes 4 is being compressed (see FIG. 5(b)). On the other hand, it has been confirmed that, in sample 1, each of the carbon nanotubes 4 has hardly been compressed because of coverage with the amorphous carbon 6 and the length of each of the carbon nanotubes is hardly changed in a growing direction (variation is 10% or less).

Subsequently, the granular sulfur 51 was placed over an entire area of samples 1 and 2 in which the carbon nanotubes had been grown, and was heated at 120° C. in an atmosphere of Ar for five minutes. After heating, annealing was performed at 180° C. for 30 minutes, and also the insides of the carbon nanotubes 4 were filled with the sulfur 5 to obtain the positive electrode P. The final weight ratio between the carbon nanotubes 4 and the sulfur 5 was 3:2, and the weight of the sulfur was 15 mg.

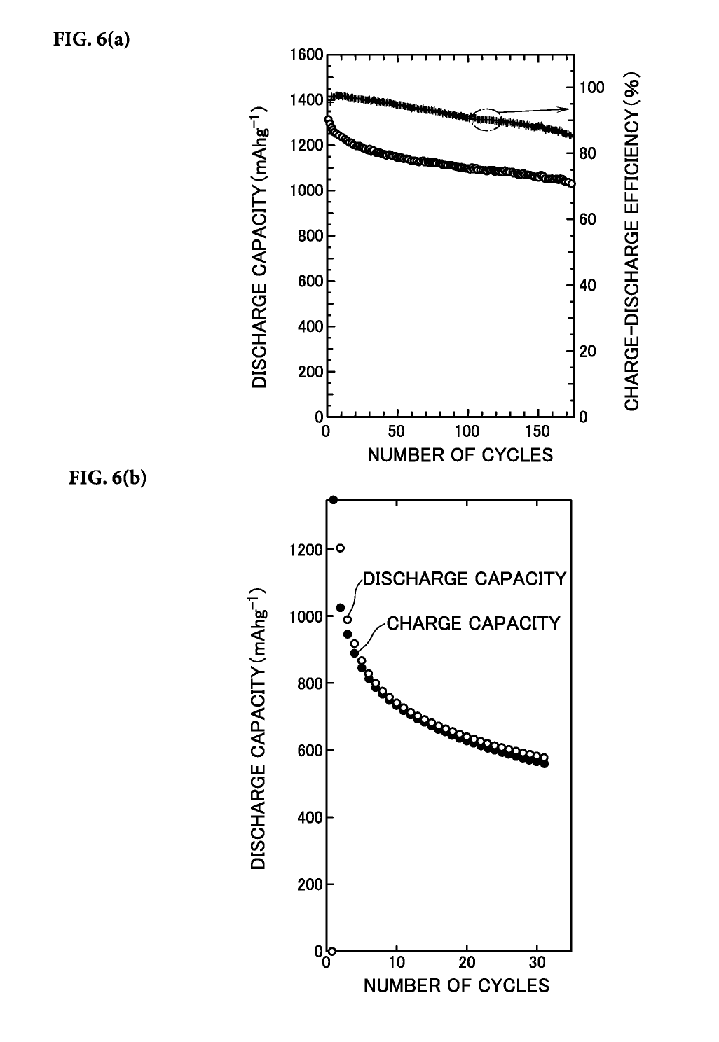

FIGS. 6(a) and 6(b) are graphs showing charge-discharge characteristics of samples 1 and 2, obtained by repeating charge and discharge multiple times after a lithium-sulfur secondary battery is assembled using sample 1 or 2. This indicates that, in sample 2, the charge-discharge capacity is reduced with increase of the number of charge-discharge (30 times) (see FIG. 6(b)). This is caused by a fact that sulfur is eluted also into an electrolytic solution far away from a positive electrode due to poor adhesion of the sulfur to carbon nanotubes and that an active material is lost. On the other hand, in sample 1, even when the number of charge-discharge is increased, a reduction ratio of the discharge capacity is low. Even when charge and discharge are repeated 180 times, the discharge capacity is 1000 mAhg⁻¹, and the charge-discharge efficiency is 85% (see FIG. 6(a)). It is considered that this is caused by the strength obtained by covering carbon nanotubes with amorphous carbon.

Hereinabove, the embodiment of the invention has been described. However, this invention is not limited to those described above. The above embodiment has been described by taking as an example a case where the carbon nanotubes are grown directly on the surface of the catalyst layer 3. However, the carbon nanotubes may be grown in an oriented manner on a surface of another catalyst layer, and these carbon nanotubes may be transferred onto the surface of the catalyst layer 3. The above embodiment has been described by taking as an example a case where the first step and the second step are performed in the same film-forming chamber. However, the first step and the second step can be performed in different film-forming chambers, and the kind of a gas can be changed in this case.

In the above embodiment, only the surface of each of the carbon nanotubes 4 is covered with the sulfur 5. However, if the inside of each of the carbon nanotubes 4 is also filled with the sulfur, the amount of the sulfur in the positive electrode P is further increased, and the specific capacity can be thereby further increased. In this case, an opening is formed at a tip end of each of the carbon nanotubes through heat treatment at a temperature of 500 to 600° C. in the atmosphere, for example, before sulfur is placed thereon. Subsequently, in a manner similar to the above embodiment, sulfur is disposed over the entire area where the carbon nanotubes have been grown, and the sulfur is melted. With this treatment, a surface of each of the carbon nanotubes is covered with sulfur, and the inside of each of the carbon nanotubes is also filled with sulfur through the opening simultaneously. The weight of sulfur is preferably set to a value 5 to 20 times that of carbon nanotubes.

In another method of filling the insides of the carbon nanotubes with sulfur, after the surface of each of the carbon nanotubes 4 is covered with the sulfur 5 by melting the sulfur in a heating furnace, annealing is further performed by using the same heating furnace at a temperature of 200 to 250° C. at which the collector metal and the sulfur are unreactive. This annealing makes sulfur permeate the carbon nanotubes 4 from the surfaces thereof, and thereby the inside of each of the carbon nanotubes 4 is filled with the sulfur 5.

### REFERENCE MARKS

BT lithium-sulfur secondary battery
P positive electrode
P₁ collector
1 substrate
3 catalyst layer
4 carbon nanotube
5 sulfur
6 amorphous carbon

1. In a positive electrode for a lithium-sulfur secondary battery comprising:
a collector;
a plurality of carbon nanotubes which are grown on a surface of the collector such that the collector-surface side serves as a base end and so as to be oriented in a direction perpendicular to the surface of the collector;
each of the carbon nanotubes being respectively covered with sulfur on a surface thereof, the surface of each of the carbon nanotubes being covered with sulfur by melting and diffusing sulfur from a growing end side of the carbon nanotubes,
characterized in that the density per unit volume of the carbon nanotubes is set such that, when sulfur is melted and diffused, sulfur is present up to an interface between the collector and the base end of each of the carbon nanotubes; and
that the positive electrode further comprises amorphous carbon covering the surface of each of the carbon nanotubes.

2. The positive electrode for a lithium-sulfur secondary battery according to claim 1, wherein
the density is 0.025 g/cm³ or less and within a range capable of obtaining a predetermined specific capacity.

3. A method of forming a positive electrode for a lithium-sulfur secondary battery, comprising:
a growth step of forming a catalyst layer on a surface of a substrate and growing a plurality of carbon nanotubes on a surface side of the catalyst layer such that the catalyst-layer side surface serves as a base end and so as to be oriented in a direction perpendicular to the surface of the catalyst layer, and
a coverage step of melting and diffusing sulfur from the growing end side of each of the carbon nanotubes and covering a surface of each of the carbon nanotubes with sulfur,
characterized in that the growth step includes:
a first step of growing the carbon nanotubes by setting the concentration of a hydrocarbon gas to a first concentration using a CVD method in which a mixed gas of the hydrocarbon gas and a diluent gas are used as a raw material gas, and
a second step of covering the surface of each of the carbon nanotubes with amorphous carbon by setting the concentration of the hydrocarbon gas to a second concentration higher than the first concentration.

4. The method of forming a positive electrode for a lithium-sulfur secondary battery according to claim 3, wherein
the hydrocarbon gas is selected from acetylene, ethylene, and methane.

5. The method of forming a positive electrode for a lithium-sulfur secondary battery according to claim 3, wherein
the first concentration is a range from 0.1% to 1%, and the second concentration is a range from 2% to 10%.

6. The method of forming a positive electrode for a lithium-sulfur secondary battery according to claim 4, wherein
the first concentration is a range from 0.1% to 1%, and the second concentration is a range from 2% to 10%.
